(19) United States
(12) Patent Application Publication
(10) Pub. No.: US 2019/0152807 A1
(43) Pub. Date: May 23, 2019

(54) IMMOBILIZATION OF PARTICLES ON A MATRIX

(71) Applicant: Advantageous Systems LLC, Los Angeles, CA (US)

(72) Inventors: Adam L. Stein, Pasadena, CA (US); Matthew Huber, La Jolla, CA (US); Jorge Gomez Galeno, La Jolla, CA (US)

(21) Appl. No.: 16/110,105

(22) Filed: Aug. 23, 2018

Related U.S. Application Data
(63) Continuation of application No. 14/681,186, filed on Apr. 8, 2015, now abandoned.
Application No. 14/681,186 is a continuation of application No. PCT/US2013/064622, filed on Oct. 11, 2013.
(60) Provisional application No. 61/713,468, filed on Oct. 12, 2012.
(60) Provisional application No. 61/727,049, filed on Nov. 15, 2012.

(51) Int. Cl. C02F 1/28; B01J 20/26; B01J 20/28; B01J 20/32; C02F 5/00; B01J 20/06

(52) U.S. Cl. CPC C02F 1/288; C02F 1/281; B01J 20/261; B01J 20/28007; C02F 2101/20; C02F 5/00; C02F 1/285; B01J 20/06; B01J 20/3236; B01J 20/321

(57) ABSTRACT

A method for removing a contaminant from a fluid, the method comprising contacting the fluid comprising a contaminant at a first concentration with a purification medium for a time sufficient for binding of the contaminant to the medium to provide and effluent comprising the contaminant at a second concentration, wherein the second concentration is lower than the first concentration.

### CROSS REFERENCE TO RELATED APPLICATIONS

This application is a continuation of U.S. application Ser. No. 14/681,186, filed Apr. 8, 2015, which is a continuation of International Application No. PCT/US2013/064622, filed Oct. 11, 2013, which claims priority to U.S. Application No. 61/713,468, filed Oct. 12, 2012 and U.S. Application No. 61/727,049 filed Nov. 15, 2012, the contents of each of which is incorporated by reference herein.

### FIELD OF THE INVENTION

This invention relates to a method for removing contaminants from a fluid.

### BACKGROUND

Increased levels of arsenic in drinking water have been correlated with higher incidence of various cancers. Many approaches have been proposed for the effective removal of arsenic, with one of the best recognized methods being the use of iron oxides, including magnetite. Herein we propose a method for the immobilization of nanoparticles of transition metals salts, e.g. iron oxide(s), on a matrix, which may be a polymeric matrix, that works effectively for the removal of arsenic from water.

### SUMMARY

A method for removing a contaminant from a fluid, the method comprising contacting the fluid comprising a contaminant at a first concentration with a purification medium for a time sufficient for binding of the contaminant to the medium to provide an effluent comprising the contaminant at a second concentration, wherein the second concentration is lower than the first concentration.

In one embodiment, the fluid is a liquid, and more particularly water. In one embodiment, the contaminant is a biologic, small molecule organic, analyte, cation, anion, ampholyte, zwitterion, or a combination thereof.

In one embodiment, the contaminant is selenium, selenate, selenite, selenide dimethyl selenide, selenomethionine, selenocysteine, methyl selenocysteine, a selenium isotope, calcium ion, magnesium ion, lead ion, an arsenic salt, an arsenate salt, a radium salt, or a combination of two or more thereof.

In one embodiment, the purification medium comprises a matrix. In certain aspects of this embodiment, the matrix comprises a polymer, and as such is a polymer matrix. In one embodiment, the polymer comprises a polypropylene polymer.

In another embodiment, the purification medium comprises a non-polymeric matrix.

In one embodiment, the matrix comprises particles comprising transition metal salts. In one embodiment, the particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the iron is in the form of an iron salt. In one embodiment, the iron comprises a mixture of ferrous chloride and ferric chloride. In one embodiment, the particles are distributed throughout the matrix and wherein the particles are formed in situ. In one embodiment, the particles comprise ferrous chloride and ferric chloride. In one embodiment, the fluid is drinking water and the contaminant comprises arsenic. In one embodiment, the particles are nanoparticles.

There is also described a method for preparing a treated matrix for use in a purification medium, the method comprising contacting a matrix with an aqueous composition comprising precursors of particles to provide a primary matrix, contacting a primary matrix with an aqueous solution comprising a base to provide a secondary matrix, and drying the secondary matrix to provide the treated matrix. In one embodiment, the purification medium is suitable for use in the aforementioned method for removing a contaminant from a fluid. In one embodiment, the particles comprise one or more of comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the particles are nanoparticles and the nanoparticles are distributed throughout the treated matrix. In one embodiment, the base is ammonium hydroxide, sodium hydroxide, or a combination thereof. In one embodiment, the particles comprise ferrous chloride and ferric chloride.

In one embodiment, there is provided a treated matrix prepared by the aforementioned method for preparing a treated matrix for use in a purification medium.

There is also provided a fluid-purifying matrix, wherein the matrix comprises particles comprising a transition metal or a salt thereof, wherein said particles are formed in situ, and wherein said particles are substantially uniformly distributed throughout the said matrix. In one embodiment, the particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the particles comprise nanoparticles. In one embodiment, the particles comprise ferrous chloride and ferric chloride. In one embodiment, the matrix comprises a polymer, such as a polypropylene polymer.

There is also provided a fluid filtration membrane comprising the aforementioned fluid-purifying matrix.

In other embodiments, the matrix comprises pre-formed particles comprising transition metal salts, i.e., particles that are not formed in situ, as described above.

In still other embodiments, the matrix comprises both in situ formed particles comprising transition metal salts as well as pre-formed particles comprising transition metal salts. In particular aspects, either or both of the in situ formed and pre-formed particles are nano-particles.

In one embodiment, the pre-formed particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the iron is in the form of an iron salt. In one embodiment, the iron comprises a mixture of ferrous chloride and ferric chloride. In one embodiment, the particles are distributed throughout the matrix and wherein the particles are formed in situ. In one embodiment, the particles comprise ferrous chloride and ferric chloride. In one embodiment, the fluid is drinking water and the contaminant comprises arsenic. In one embodiment, the particles are nanoparticles.

There is also described a method for preparing an activated matrix for use in a purification medium, the method comprising contacting a matrix with pre-formed particles to provide the activated matrix. In one embodiment, the purification medium is suitable for use in the aforementioned method for removing a contaminant from a fluid. In one embodiment, the pre-formed particles comprise one or more of comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the pre-formed particles are nanoparticles that are distributed throughout the activated matrix. In one embodiment, the pre-formed particles comprise ferrous chloride and ferric chloride.

In one embodiment, there is provided an activated matrix prepared by distributing the pre-formed particles to a matrix to provide an activated matrix for use in a purification medium.

There is also provided a fluid-purifying activated matrix, wherein the matrix comprises pre-formed particles comprising a transition metal or a salt thereof, wherein said particles are pre-formed and, in particular embodiments, are substantially uniformly distributed throughout the matrix. In one embodiment, the pre-formed particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof. In one embodiment, the pre-formed particles comprise nanoparticles. In one embodiment, the pre-formed particles comprise ferrous chloride and ferric chloride. In one embodiment, the matrix comprises a polymer, such as a polypropylene polymer. In other embodiments, the matrix is a non-polymeric matrix.

There is also provided a fluid filtration membrane comprising the aforementioned fluid-purifying activated matrix.

### BRIEF DESCRIPTION OF THE DRAWINGS

FIG. 1 illustrates one embodiment of a closed-loop system for loading iron oxides onto a filter.

FIG. 2 illustrates one embodiment of a system for the treatment of arsenic-contaminated water.

### DETAILED DESCRIPTION OF THE PREFERRED EMBODIMENTS

The description of illustrative embodiments according to principles of the present invention is intended to be read in connection with the accompanying drawings, which are to be considered part of the entire written description. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless specifically noted, references to particles and nanoparticles are intended to encompass both pre-formed particles and nanoparticles as well as those particle and nanoparticles formed in situ in matrices as described herein.

Although treated matrices and activated matrices are described above, the present invention encompasses membranes comprising both “treated” and “activated” matrices, i.e., those comprising particles formed in situ, and those comprising pre-formed particles. The presently-described invention therefore includes membranes comprising both pre-formed and in situ formed particles. In particular aspects, either or both of pre-formed and in situ formed particles are nanoparticles. In other aspects, either or both of the “treated” and the “activated” matrices are polymeric matrices, while in still further aspects of the present invention, either or both of the “treated” and the “activated” matrices are non-polymeric matrices.

Particles and nanoparticles useful in the practice of the present invention include synthetic analogues of suitable materials or combinations of materials, such as magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, and combinations thereof. Those particles may be of variable size and shape.

Mineral nanoparticles, per se, may have some binding properties provided by hydroxyl or other surface groups. Generally however, they do not have sufficient functionality to be operable in the disclosed processes. Functionality is achieved by actively changing the surface groups either by maximizing the number of charged groups on the surface of the nanoparticles or by coating with a polymer or other material to obtain a surface functionalized by carboxyl, amine, or other reactive groups.

In certain embodiments, therefore, the present invention provides methods for the synthesis of nanoparticles or other nanomaterials that have been surface functionalized with a given surface charge or conjugated to binding molecules such as receptors.

In one embodiment, this disclosure relates to a novel nano-functionalized material comprising nanoparticles, e.g., iron oxide nanoparticles, that are surface functionalized with surfactant with high binding specificity for selenate ions. The resulting nano-functionalized material will be capable of binding selenite. In another embodiment, this disclosure relates to a novel nano material comprising nanoparticles, e.g., iron oxide nanoparticles, that have a high surface ratio that are monodispersed and have no surfactants with high binding specificity for selenate ions. The resulting nano-functionalized material will also be capable of binding selenate.

In another embodiment, this disclosure relates to a novel nano-functionalized material comprising nanoparticles, e.g., iron oxide nanoparticles, that is surface functionalized with surfactant with high binding specificity for sodium ions. The resulting nano-functionalized material will be capable of binding sodium.

Nanoparticles of many types are useable in the disclosed processes and may be synthesized by various known means or by the novel methods disclosed herein. For example, useful nanoparticles can be synthesized using a known thermal decomposition of a metal precursor method, as disclosed in C. Barrera, A. P. Herrera, C. Rinaldi, Colloidal dispersions of monodisperse magnetite nanoparticles modified with poly(ethylene glycol). J Colloid Interface Sci. (2009), vol. 329, pg. 107-113, which is hereby incorporated herein by reference, as well other methods known to a practitioner in the art or by the novel methods disclosed hereinafter.

For example, thermal decomposition in the presence of a stabilizing ligand as a surfactant and co-precipitation with or without a stabilizing ligand as a surfactant, describe methods of synthesizing nanoparticles.

In certain embodiments, nanoparticles useful according to the present disclosure can range in diameter, between about 1 nm and about 500 nm, preferably 1 to 50 nm most preferably 1 to 20 nm.

Useful nanoparticles, e.g., iron oxide nanoparticles, can be produced by high-temperature methods, such as thermal decomposition of a metal precursor in the presence of a stabilizing ligand as a surfactant. Surfactants such as oleic acid and/or oleylamine help prevent agglomeration of the nanoparticles, as well as control growth during synthesis.

Suitable metal precursors include, but are not limited to, carbonyl and acetylacetonate complexes (Fe(CO)₅ and Fe(acetylacetonate)₃.

Such thermal decomposition reactions may be conducted in inert atmospheres. Subsequent to thermal decomposition, mild oxidation with trimethylamine oxide ((CH₃)₃NO) at elevated temperatures can be performed.

Other synthesis techniques can be used to modify nanoparticle properties as desired, such as, for example, co-precipitation, microemulsion, and hydrothermal synthesis.

In certain embodiments, other metals such as Co²⁺ or Mn²⁺, can be included to form CoFe₂O₄ or MnFe₂O₄ useful nanoparticles.

In other embodiments, a mixture of different types and/or sizes of nanoparticles can be used. In this manner different target molecules or different compounds of the same target molecule may be removed simultaneously.

The nanoparticles are preferably monodispersed after synthesis to facilitate further processing and high surface area to volume ratio. The addition of surfactants that are surface active agents facilitates such dispersion.

In certain embodiments, nanoparticles may be used as such, or they may be surface functionalized with a coating, to enhance their specificity and their affinity for a specific target contaminant. For example, dextran, sugars, PEG, PEG-OH, other modified PEG moieties, polyvinyl alcohol, gold, azide, carboxyl groups, activated carbon, zeolites, amine, poly acrylic acid, charged polymers, or others may be used as surface functionalization.

In one embodiment macrocycle structures are acceptable for use as Na and Cl receptors.

The nanoparticles may be used as such, or they may be coated and/or complexed with a target specific receptor. The nanoparticles may be coated to enhance specificity and/or affinity to the specific target or to promote the ability of the nanoparticles to complex with the target specific receptor.

In certain embodiments poly acrylic acid is used as a surface functionalized coating for adsorption of sodium onto the nanoparticles. Poly-acrylic acid serves to adsorb sodium while still maintaining monodispersity of the transition metal nanoparticles, e.g., iron oxide nanoparticles, allowing for high surface area to volume ratio for greater sodium binding per amount of material used.

In one embodiment, PEG-OH is used as a surface functionalized coating for adsorption of selenate onto nanoparticles. The PEG-OH serves to adsorb selenate while still maintaining monodispersity of the transition metal nanoparticles, e.g., iron oxide nanoparticles, allowing for high surface area to volume ratio for greater selenate binding per amount of material used.

The coating/linker may be a polyether. Polyethers are bi- or multifunctional compounds with more than one ether group such as polyethylene glycol and polypropylene glycol. Crown Ethers are other examples of low-molecular polyethers suitable for use in the described processes. For example, polyethylene glycol (PEG) typically refers to oligomers and polymers with a molecular mass below 20,000 g/mol, polyethylene oxide (PEO) to polymers with a molecular mass above 20,000 g/mol, and POE to a polymer of any molecular mass. Polypropylene glycol's (PPG) secondary hydroxyl groups are less reactive than primary hydroxyl groups in polyethylene glycol but may be used. Polyvinyl alcohol of any molecular mass that have reactive hydroxyl groups may also be used.

Most PEGs are polydisperse; they include molecules with a distribution of molecular weights. In one aspect of this embodiment, the polyether is PEG with an average molecular weight in the range of 400-2400 MW.

In certain embodiments, Other bi- or multifunctional groups can function as coatings/linkers in the present process.

For example, nanoparticles useful according to the present disclosure may be functionalized with amine groups, e.g., generally according to a method disclosed in C. Barrera, A. P. Herrera, C. Rinaldi, Colloidal dispersions of monodisperse magnetite nanoparticles modified with poly(ethylene glycol). J Colloid Interface Sci. (2009), vol. 329, pg. 107-113. In one variation of that method, instead of using mPEG-COOH and reacting it with 3-aminopropyl)-triethoxysilane to form silane-PEG and then reacting that with nanoparticles, the alternative process uses silane conjugation, which is only reacted with (3-aminopropyl)-triethoxysilane to form amine conjugated nanoparticles ready to react with receptors.

In another embodiment, nanoparticles may also be amine conjugated by reacting with (3-aminopropyl)-triethoxysilane, toluene, and acetic acid with vigorous stirring. The product is decanted and washed with toluene and dried under vacuum.

In another embodiment, useful nanoparticles carry an amide linked ion receptor. Here, for example, amine functionalized nanoparticles produced may be cross-linked to synthesized ion receptors that selectively bind to sodium cations and chloride anions. The ion receptors will have an additional functional group such as a carboxylic acid that will bind to the amine group of the nanoparticles forming a peptide bond.

Other linkers useful in embodiments of the present disclosure may also be utilized including azide, thiol, ester, and the like. For example, ion receptors are composed of macrocycle structure containing compounds or crown ethers. The macrocycle is capable of binding to chloride anions and the crown ether will bind to sodium cations. Multiple functional receptors may also be utilized.

Other useful linkers for linking multifunctional or more than one type of receptor to surface functionalized nanoparticles include, by way of non-limiting example, siloxane, maleimide, dithiol, ester, as well as other linkers.

In another embodiment, useful nanoparticles include doubly functionalized nanoparticles carrying both an amide-linked cation receptor and a triazine-tethered anion receptor. Single ion receptors can be individually linked to nanoparticles with amide linkage for cation receptors or triazine-tethered for anion receptors. However, nanoparticles can also be functionalized with both amine groups and azide anions that form an amide link to the cation sodium receptor or a triazine-tethered link to the chloride anion receptor.

In addition, receptors may be linked directly to functionalized nanoparticles or poly(ethylene glycol) (PEG) spacers are used with modified ends to link nanoparticles to individual receptors. PEG spacers, which possess, favorable solubility characteristics in aqueous systems, reduction of non-specific binding, enhanced stability, and better monodispersity.

In other embodiments, individual cation and anion receptors are capable of selectively binding to sodium and chloride, respectively. The sodium cation receptors are composed of a crown ether and the chloride anion receptor is composed of a macrocycle. Similar individual ion receptors capable of binding to other cations and anions such as potassium, chloride, or fluoride have been synthesized.

In certain aspect, PEG spacers of varying length are used to link nanoparticles to ion receptors. These spacers can be used to coat the nanoparticles for favorable solubility characteristics in aqueous solution, reduction of non-specific binding, enhanced stability, and monodispersity. In various aspects of this embodiment the PEG chain lengths may vary from 4-24 monomeric units, or longer, depending on the specific receptor.

In one specific embodiment, the nanoparticles are PEGylated with a carboxy-PEG-amine PEGylation reagent, which will bind to the amine groups on the surface of nanoparticles by a peptide bond between the carboxyl group on one end of the PEG with an amine group of the nanoparticles. The resulting PEGylated nanoparticles will consist of nanoparticles attached to PEG chains that end with amine groups on their unbound ends. These amine groups, attached to the ends of the PEG chains, can act as the binding site for the modified carboxylic acid terminated ion pair multiple receptor or individual ion receptor.

In other embodiments the nanoparticles are conjugated to a binding molecule that is selective to one or more specific target molecules, including specifically targeted contaminants, as well as analytes, cations, anions, and/or small molecule biological materials. The specific binding molecule is chosen based on the target to be bound.

In one approach, the nanoparticles are sonicated and amine conjugated by reacting with (3-aminopropyl)-triethoxysilane, toluene, and acetic acid with vigorous stirring. Typical conditions for conjugation are a temperature of from 15 to 30° C., or from 17.5 to 25° C. for a period of from 48 to 90 hours, e.g., from 60 to 80 hours.

In other embodiments, surfactants may be synthesized around the nanoparticles such as polyethylene glycol (PEG) or gold and the nanoparticles used without complexing with a receptor or, in another embodiment, the nanoparticles may be attached to a receptor specific to the selected target or targets.

Various moieties may be utilized to functionalize the surface of the nanoparticles, including as non-limiting examples, PEG, gold, amines, carboxyl groups, thiols, azides, or other linkers. In other aspects of these embodiments, synthetic receptors are then conjugated to the surface of the nanoparticles. Single receptors for individual contaminants, analytes or multispecific receptors for two or more different contaminants or analytes are complexed/conjugated to the nanoparticles. The use of two or more monospecific receptors on the same nanoparticle is also within the scope of this disclosure.

In particular embodiments, different linkers may be used to link the mono or multifunctional receptors to surface functionalized nanoparticles including, as nonlimiting examples, siloxanes, maleimides, dithiols or the receptors may be directly coupled to the nanoparticles.

Reaction conditions and analytical methods for following and characterizing these conjugation steps are known in the art and include, as but one example, those described and referenced in U.S. Patent Application Publication No. US 2012/0018382 A1, which is incorporated by reference herein.

As noted herein, contaminants and analytes, ions, and/or molecules that are of specific interest and that are capable of being extracted from a fluid using the presently described materials and systems include but are not limited to biologics and small molecules such as viruses, bacteria, antibodies, nucleic acids, proteins, cells, fatty acids, amino acids, carbohydrates, peptides, pharmaceutical products, toxins, pesticides and other organic materials; anions such as fluoride, chloride, bromide, sulfate, nitrate, silicate, chromate, borate, cyanide, ferrocyanide, sulfite, thiosulfate, phosphate (phosphorus), perchlorate, selenium compounds; cations such as sodium, potassium, calcium, magnesium, manganese, aluminum, nickel, ammonium, copper, iron, zinc, strontium, cadmium, silver, mercury, lead, arsenic selenium, gold and uranium. The processes and materials are unlimited with respect to the contaminant/target and any contaminant/target of interest may be chosen using an appropriate receptor selected from the receptors disclosed herein.

For example, when selenium is the target, it may be in elemental form, as selenate, selenite, selenide, ionic forms, oxidated forms, found in organic compounds such as dimethyl selenide, selenomethionine, selenocysteine and methylselenocysteine, selenium isotopes, or selenium combined with other substances.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

### Example 1: Immobilization of Iron Oxide Particles on a Polymeric Matrix

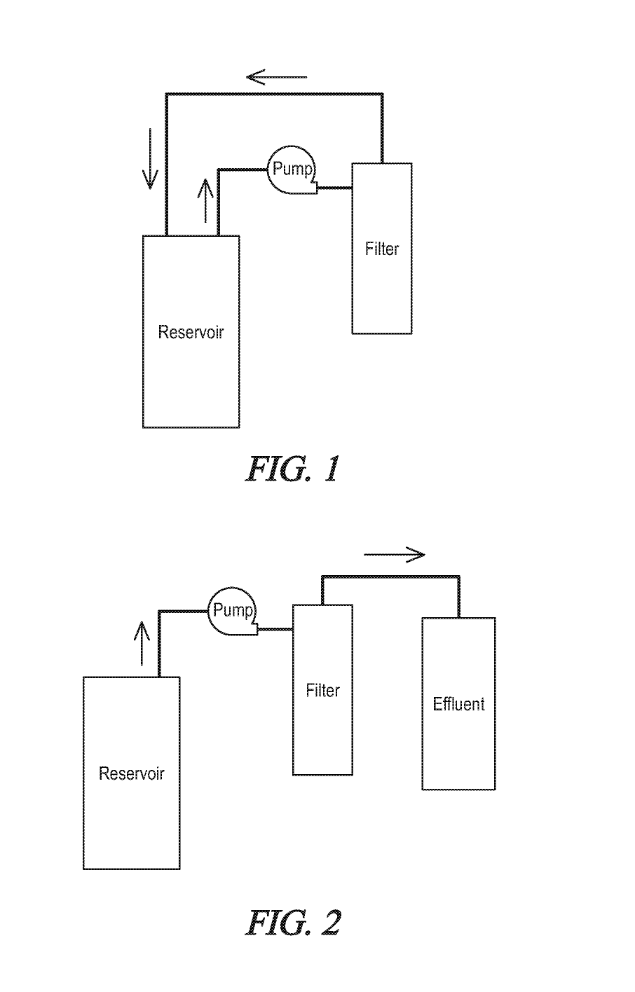

One embodiment of a closed loop system consisting of a solution reservoir, a pump and a filter (as shown in FIG. 1) was utilized for this process. A solution of ferric chloride hexahydrate (61.75 g) and ferrous chloride tetrahydrate (22.840 g) in 3 L of water was loaded in the reservoir. This solution was pumped through a polypropylene filter at a rate of 1 gpm for forty minutes. The iron solution was replaced by a solution containing an excess of ammonium hydroxide and sodium hydroxide. The basic solution was pumped through the filter until the effluent was colorless and then for an additional ten minutes. The filter was then air dried for a period of one hour.

Utility.

An open system was utilized for this demonstration, as shown in FIG. 2. A solution of tap water that was spiked with an arsenite standard was loaded in the reservoir. The water was then pumped at 0.66 gpm through the filter obtained in the step above. The arsenic levels in the effluent decreased from 150 ppb to 3.3 ppb.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for removing a contaminant from a fluid, the method comprising contacting the fluid comprising a contaminant at a first concentration with a purification medium for a time sufficient for binding of the contaminant to the medium to provide an effluent comprising the contaminant at a second concentration, wherein the second concentration is lower than the first concentration, wherein the purification medium comprises a matrix, and wherein the matrix is a non-polymeric matrix or a polymeric matrix.

2. The method of claim 1, wherein the fluid is a liquid.

3. The method of claim 2, wherein the fluid is water.

4. The method of claim 2, wherein the contaminant is a biologic, small molecule organic, analyte, cation, anion, ampholyte, zwitterion, or a combination thereof.

5. The method of claim 4, wherein the contaminant is selenium, selenate, selenite, selenide dimethyl selenide, selenomethionine, selenocysteine, methyl selenocysteine, a selenium isotope, calcium ion, magnesium ion, lead ion, an arsenic salt, an arsenate salt, a radium salt, or a combination of two or more thereof.

6. The method of claim 1, wherein the matrix comprises a polypropylene polymer.

7. The method of claim 1, wherein the matrix comprises particles comprising transition metal salts.

8. The method of claim 7, wherein the particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof.

9. The method of claim 8, wherein the iron is in the form of an iron salt.

10. The method of claim 9, wherein the iron comprises a mixture of ferrous chloride and ferric chloride.

11. The method of claim 7, wherein the particles are distributed throughout the matrix and wherein the particles are selected from the group consisting of particles formed in situ, pre-formed particles, and combinations thereof.

12. The method of claim 11, wherein the fluid is drinking water and the contaminant comprises arsenic.

13. A method for preparing a treated matrix for use in a purification medium, the method comprising contacting a matrix with an aqueous composition comprising precursors of particles to provide a primary matrix, contacting the primary matrix with an aqueous solution comprising a base to provide a secondary matrix, and drying the secondary matrix to provide the treated matrix.

14. The method of claim 13, wherein said particles comprise one or more of magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof.

15. The method of claim 13, wherein said particles are nanoparticles and the nanoparticles are distributed throughout the treated matrix.

16. The method of claim 15, wherein the base is ammonium hydroxide, sodium hydroxide, or a combination thereof.

17. The method of claim 16, wherein said particles comprise ferrous chloride and ferric chloride.

18. A fluid-purifying matrix, wherein the matrix comprises particles comprising a transition metal or a salt thereof, wherein said particles are formed in situ, and wherein said particles are substantially uniformly distributed throughout the said matrix.

19. The matrix of claim 18, wherein the particles comprise magnetite, ulvospinel, hematite, ilmenite, maghemite, jacobsite, trevorite, magnesioferrite, pyrrhotite, greigite, troilite, goethite, lepidocrocite, feroxyhyte, iron, nickel, cobalt, awaruite, wairauite, or a combination of two or more thereof.

20. The matrix of claim 18, wherein the particles comprise ferrous chloride and ferric chloride.

21. The matrix of claim 18, wherein the matrix comprises a polymer.

22. The matrix of claim 21, wherein the polymer comprises a polypropylene polymer.

23. A fluid filtration membrane comprising the matrix of claim 18.
